(19) United States
(12) Patent Application Publication
(10) Pub. No.: US 2026/0145082 A1
(43) Pub. Date: May 28, 2026

(54) GAME SNAPSHOT CAPTURE AND FIXER

(71) Applicant: Sony Interactive Entertainment Inc., Tokyo (JP)

(72) Inventors: Chockalingam Ravi Sundaram, San Mateo, CA (US); Doron Griss, San Mateo, CA (US); Murshed Choudhury, San Mateo, CA (US); Edward Yet Bunn Cheung, San Mateo, CA (US)

(21) Appl. No.: 18/961,167

(22) Filed: Nov. 26, 2024

(51) Int. Cl. A63F 13/77; A63F 13/358; A63F 13/67

(52) U.S. Cl. CPC A63F 13/77; A63F 13/358; A63F 13/67

(57) ABSTRACT

During quality assurance (QA) execution of a computer game, potential issues such as such as frame rate drop are identified, at which point a snapshot is taken to identify where the draw calls are excessive. A machine learning (ML) model attempts to repair the code and if successful commits to version control. Such repair may include, e.g., adjusting tessellation rate and shader operations. If repair is not successful the developer is notified. Also applies to exceptions and network lag.

### FIELD

The present application relates generally to computer game snapshot capture and fixers.

### BACKGROUND

With the increasing complexity of computer games or video games, the possibilities of game design and code requiring monitoring and attention increases.

### SUMMARY

As understood herein, machine learning (ML) can be leveraged to identify and repair exceptions in complex games.

Accordingly, an apparatus includes at least one processor system configured to execute a computer game. The processor system is configured to, during execution of the computer game, generate a snapshot of the computer game responsive to identifying an issue with execution of the computer game, and use the snapshot to identify at least one cause of the issue. The processor system is configured to attempt to correct the cause of the issue and responsive to correcting the cause of the issue, commit correction of the cause to version control. The processor system is further configured to, responsive to not correcting the cause of the issue, notify a developer of the computer of the issue.

In some examples the issue includes frame rate drop and attempting to correct the cause of the issue includes adjusting shader operation and/or tessellation rate. In other examples the issue includes at least one exception and attempting to correct the cause of the issue includes adjusting at least one game parameter. In still other examples the issue includes network lag and attempting to correct the cause of the issue includes adjusting at least one parameter related to latency.

In non-limiting examples the processor system may be configured to identify potential similar issues in code of the computer game, and prospectively correct the similar issues.

In some implementations the processor system can be configured to attempt to correct the cause of the issue using at least one machine learning (ML) model.

In another aspect, an apparatus includes computer memory that is not a transitory signal and that in turn includes instructions executable by at least one processor system to, based at least in part on at least one snapshot of at least one computer game, identify an issue in execution of the computer game, and execute at least one machine learning (ML) model to attempt to correct the issue.

In another aspect, a method includes, during quality assurance (QA) execution of a computer game, identifying a frame rate drop. The method also includes, responsive to identifying the frame rate drop, generating a snapshot of the computer game and using the snapshot to identify draw calls meeting a threshold. The method includes addressing the draw calls meeting a threshold at least in part by adjusting tessellation rate and/or shader operations.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example system in accordance with present principles;

FIG. 3 illustrates example overall logic in example flow chart format;

FIG. 4 illustrates first example specific logic in example flow chart format;

FIG. 5 illustrates second example specific logic in example flow chart format;

FIG. 6 illustrates third example specific logic in example flow chart format;

FIG. 7 illustrates example training logic in example flow chart format;

FIG. 8 illustrates an example user interface (UI) consistent with present principles; and

FIG. 9 illustrates example prospective repair logic in example flow chart format.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

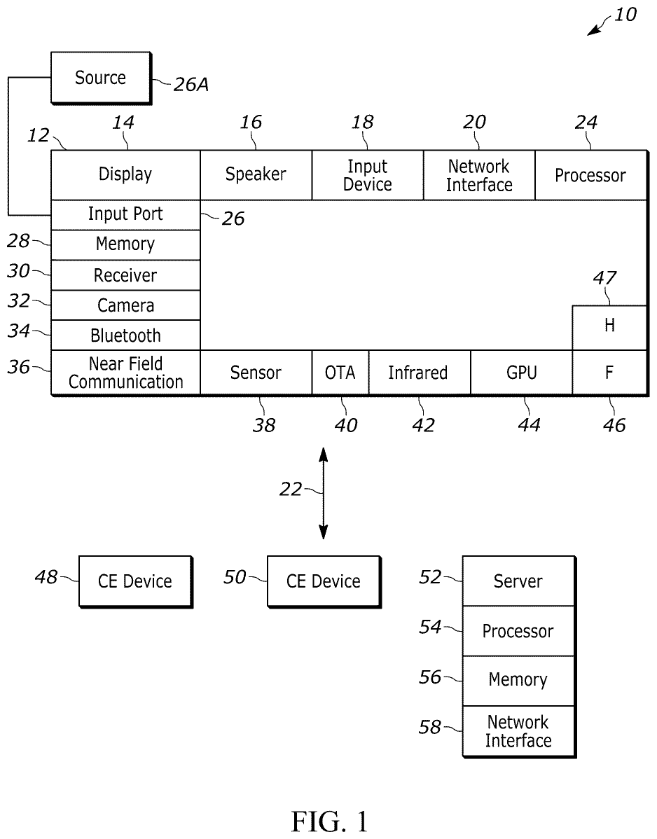

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be-1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative models such as large language models (LLM) such as generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

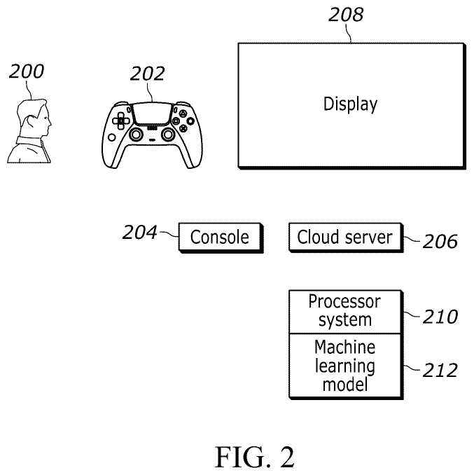

Refer now to FIG. 2. A user 200 such as a computer quality assurance (QA) technician playing a game for QA purposes can manipulate a computer game controller 202 to control play of a computer game sourced from a computer game console 204 and/or from a cloud server 206 for presentation in a display 208. The user 200 alternatively may be a non-QA person such as a computer gamer whose play is to be analyzed.

A processor system 210 receives game play data as described further herein to analyze the game for issues using one or more machine learning (ML) models 212. The processor system 210 may be associated with the game console 204 and/or server 206.

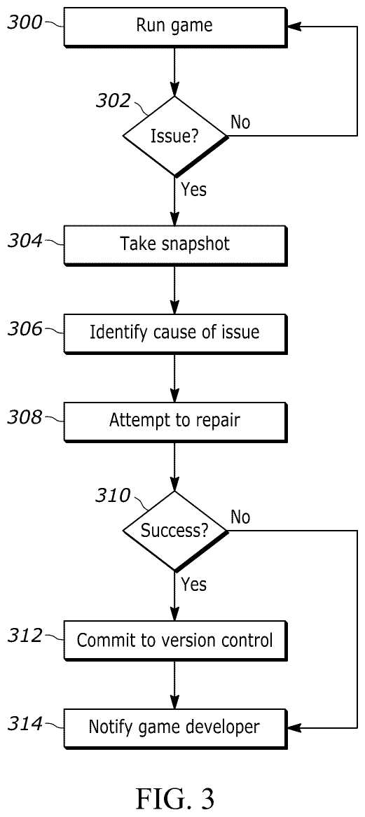

FIG. 3 illustrates that during quality assurance (QA) execution of a computer game or other type of execution, at state 300 the game is executed. The logic of FIG. 3 may be executed by the processor system 210 in FIG. 2 or other processor(s).

Moving to state 302, it is whether any issues have arisen from game play, such as a noticeable decrease in frame rate of the game video being presented. If so, a snapshot of the game may be taken at state 304, in which data from the game engine is recorded, including current number of draw calls (commands from a CPU to a GPU to draw objects), details concerning shader operations, what functions are being called in code, a captured image of the game's current state at a specific moment in time, including the positions of all characters, objects, environmental details, and the overall visual scene visible on the player's screen, and in general the full game state in a certain frame, sometimes recorded as a blob of the required data for the client to render a full scene.

By examining the data in the snapshot, the cause of the issue is identified at state 306. An attempt to repair the cause is made at state 308, and if it is determined at state 310 that the repair was successful such as by re-running the game from just before the snapshot to determine if the same issues arises or not, the new (repaired) version of the game can be committed to version control at state 312. From state 312 or from state 310 if the repair was not successful, the logic notifies the game developer of the issue, cause, which line or lines of code were repaired, and attempt to repair at state 314.

Some or all of the logic of FIG. 3 may be accomplished by executing the ML model(s) 212 in FIG. 2 on the game play data.

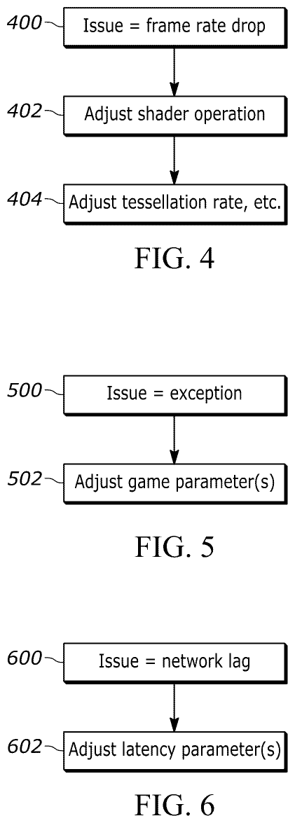

FIGS. 4-6 illustrate example issues/causes and repair techniques. Commencing at state 400 in FIG. 4, a frame rate decrease is noted. The decrease may be noted by the QA user 200 in FIG. 2 discerning a slower video speed than normal or by an ML model trained to discern reduced frame rate refresh in video. To repair the issue, shader operation may be adjusted at state 402. For example, offscreen objects can be electively hidden or occluded such that the shader need not shade such objects, or mesh decimation to use fewer triangles or other primitives in rendering objects may be implemented to reduce the shader load. In addition or alternatively, tessellation rate may be adjusted (such as by reducing the rate of tessellation) at state 404. Other techniques to reduce the number of draw calls can include the use of frame interpolation to generate frames simply by interpolating between adjacent frames, super-resolution to establish a desired resolution of video, and down-resolution of audio and/or video.

FIG. 5 illustrates another example issue, in this case, a game exception such as a game scenario keeps failing, causes a slow down of game execution, crashes of the game, soft lock of the game, etc. To address this issue, at state 502 game parameters may be adjusted. In an example, a ML model can be used to alter one or more game parameters such as number of objects, color scheme, speed of objects, static properties, and static configuration to reduce or eliminate the issue(s) identified at state 500.

FIG. 6 illustrates yet another example issue, in this network lag as determined at state 600 by a noticeable lag or latency in game presentation when sourced from the cloud server 206 in FIG. 2. To address this issue, at state 602 latency parameters may be adjusted. In an example, a ML model can be used to alter one or more latency parameters such as audio and/or video resolution (lower resolution can alleviate latency), frame rate (a lower frame rate may alleviate latency), minimizing script execution, use improved caching techniques, switch to a different server.

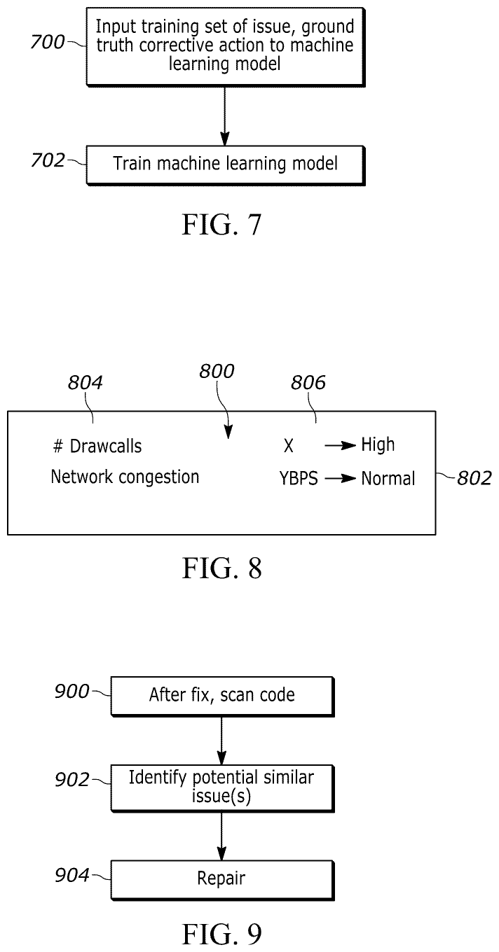

FIG. 7 illustrates example training logic. A respective ML model may be trained for each respective prospective issue to be addressed or a single ML model may be used and trained on all prospective issues to be addressed.

Commencing at state 700, a training set of data is input the ML model to train the model at state 72. A training set of data may include a set of sample instances of an issue along with ground truth corrective actions that should be used to reduce or eliminate the issue.

FIG. 8 illustrates an example UI 800 that can be presented on a display 802 such as any display herein. The UI 800 may include a column 804 of game execution elements gained from a snapshot as described above and a column 806 of commentary on the game elements in column 804. In the non-limiting example shown, a number of draw calls may be presented along with a comment that the presented number is too high. Or, a measure of network congestion may be presented such as bits per unit time and a comment that tis measure is normal.

FIG. 9 illustrates that issues can be predicted and repaired before they arise. For example, state 900 indicates that subsequent to a repair as described herein, the game code can be scanned, e.g., using a ML model trained on the prior issue and repair, to identify lines of code that potentially may cause the same or similar issues at state 902. A repair of those lines of code is attempted at state 904 consistent with techniques described herein.

While the particular embodiments are herein shown and described in detail, it is to be understood that the subject matter which is encompassed by the present invention is limited only by the claims.

What is claimed is:

1. An apparatus comprising:
at least one processor system configured to:
execute a computer game;
during execution of the computer game, generate a snapshot of the computer game responsive to identifying an issue with execution of the computer game;
use the snapshot to identify at least one cause of the issue;
attempt to correct the cause of the issue;
responsive to correcting the cause of the issue, commit correction of the cause to version control; and
responsive to not correcting the cause of the issue, notify a developer of the computer of the issue.

2. The apparatus of claim 1, wherein the issue comprises frame rate drop and attempting to correct the cause of the issue comprises adjusting shader operation.

3. The apparatus of claim 1, wherein the issue comprises frame rate drop and attempting to correct the cause of the issue comprises adjusting tessellation rate.

4. The apparatus of claim 1, wherein the issue comprises at least one exception and attempting to correct the cause of the issue comprises adjusting at least one game parameter.

5. The apparatus of claim 1, wherein the issue comprises network lag and attempting to correct the cause of the issue comprises adjusting at least one parameter related to latency.

6. The apparatus of claim 1, wherein the processor system is configured to:
identify potential similar issues in code of the computer game; and
prospectively correct the similar issues.

7. The apparatus of claim 1, wherein the processor system is configured to:
attempt to correct the cause of the issue using at least one machine learning (ML) model.

8. An apparatus comprising:
computer memory that is not a transitory signal and that comprises instructions executable by at least one processor system to:
based at least in part on at least one snapshot of at least one computer game, identify an issue in execution of the computer game; and
execute at least one machine learning (ML) model to attempt to correct the issue.

9. The apparatus of claim 8, comprising the at least one processor system.

10. The apparatus of claim 8, wherein the issue comprises frame rate drop and attempting to correct the issue comprises adjusting shader operation.

11. The apparatus of claim 8, wherein the issue comprises frame rate drop and attempting to correct the issue comprises adjusting tessellation rate.

12. The apparatus of claim 8, wherein the issue comprises at least one exception and attempting to correct the issue comprises adjusting at least one game parameter.

13. The apparatus of claim 8, wherein the issue comprises network lag and attempting to correct the issue comprises adjusting at least one parameter related to latency.

14. The apparatus of claim 8, wherein the instructions are executable to:
identify potential similar issues in code of the computer game; and
prospectively correct the similar issues.

15. A method, comprising:
during quality assurance (QA) execution of a computer game, identifying a frame rate drop;
responsive to identifying the frame rate drop, generating a snapshot of the computer game;
using the snapshot to identify draw calls meeting a threshold;
addressing the draw calls meeting a threshold at least in part by adjusting tessellation rate and/or shader operations.

16. The method of claim 15, comprising addressing the draw calls meeting a threshold at least in part by adjusting tessellation rate.

17. The method of claim 15, comprising addressing the draw calls meeting a threshold at least in part by adjusting shader operations.

18. The method of claim 15, comprising addressing the draw calls meeting a threshold at least in part using at least one machine learning (ML) model.

19. The method of claim 15, comprising prospectively correcting similar issues in code related to the computer game.
